(19) United States
(12) Patent Application Publication
(10) Pub. No.: US 2007/0070270 A1
(43) Pub. Date: Mar. 29, 2007

(54) Display

(76) Inventors: Chuan-Pei Yu, I-Lan Hsien (TW); Ming Chuan Chou, Tai-Chung Hsien (TW)

Correspondence Address: NORTH AMERICA INTELLECTUAL PROPERTY CORPORATION, P.O. BOX 506, MERRIFIELD, VA, 22116, US

(21) Appl. No.: 11/306,296

(22) Filed: Dec. 21, 2005

(30) Foreign Application Priority Data
Sep. 28, 2005 (TW) 094133751

(51) Int. Cl. G02F 1/1335

(52) U.S. Cl. 349/113

(57) ABSTRACT

A display includes a display panel, a transflective reflector positioned on a lower surface of the display panel, an upper polarizer positioned on the upper surface of the display panel, a lower polarizer positioned on the lower surface of the transflective reflector, and a backlight unit positioned below the lower polarizer. The transflective reflector partially reflects light propagating to the transflective reflector so as to improve images of the display.

### BACKGROUND OF THE INVENTION

1. Field of the Invention

The invention relates to a display, and more particularly, to a display with a transflective reflector.

2. Description of the Prior Art

As the technology advances, mobile information devices have been fully utilized in our daily lives. Flat panel displays used in the mobile information devices, therefore, had become important. Because of their advantages of light weight, low power consumption, and no radiation, flat panel displays have been widely applied in notebooks, personal digital assistants (PDAs), cellular phones, and similar mobile information devices, and become to take large market shares in the market of consuming electronics.

Since the mobile information devices must meet the requirements of the market such as light weight, small size, and low power consumption, the flat panel displays applied on these devices must have continuous developments to produce good images with low power consumption and thin thickness. Currently the industry proposed to reutilize the ambient light so that the displays may have the function of micro-reflection, which allows the display to produce clear images by micro-reflecting ambient light even though the back light module is off. Most of the manufacturers now form thin reflective layers during the fabrication process of the internal elements on the glass substrate of the display panels for creating the effects of micro-reflection. For example, in the manufacturing processes of thin film transistors (TFTs), such as micro filming or etching processes, reserving some reflective metal conducting layers in each individual pixel area may improve the brightness and quality of the images on the screen, since the metal conducting layers may micro-reflect the ambient light. However, this method complicates the original manufacturing processes and may reduce the yield rate.

### SUMMARY OF THE INVENTION

It is therefore a primary objective of the claimed invention to provide a display with a transflective reflector positioned on the lower surface of the display panel for partially reflecting ambient light to increase the brightness of displayed images and solve the above-mentioned problems.

According to the claimed invention, the display comprises a display panel, a transflective reflector positioned on the lower surface of the display panel, an upper polarizer on the upper surface of the display panel, a lower polarizer on the lower surface of the transflective reflector, and a backlight module under the lower side of the polarizer to provide the back light source for the display panel.

In the claimed invention, since a transflective reflector is positioned between the display panel and a polarizer, partial ambient light may be reflected back by the transflective reflector to the display panel to increase the brightness of the displayed images and also to decrease the utilization and power consumption of the backlight module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a cross-section schematic diagram of a display according to a first embodiment of this invention.

FIG. 2 is a schematic diagram of a frontal view of the transflective reflector in FIG. 1.

FIG. 3 and FIG. 4 are the cross-section schematic diagrams of displays according to a second and a third embodiment of this invention respectively.

FIGS. 5-7 are cross-section schematic diagrams of displays according to a forth embodiment, a fifth embodiment and a sixth embodiment of this invention respectively.

### DETAILED DESCRIPTION

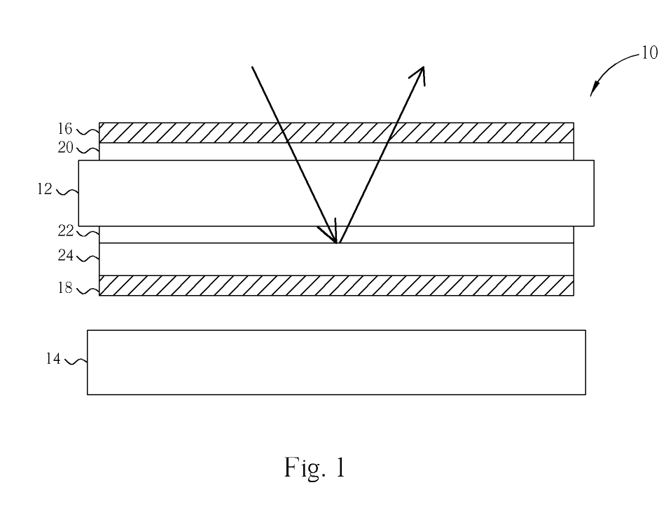

Please refer to FIG. 1. FIG. 1 is a cross-section schematic diagram of a display 10 according to a first embodiment of this invention. The display 10 comprises a display panel 12 and a backlight module 14 positioned under the display panel 12. The display panel 12 is a liquid crystal display (LCD) panel. An upper polarizer 16 is on the upper surface of the display panel 12 and a lower polarizer 18 is on the lower surface of the display panel. Between the lower polarizer 18 and the display panel 12 is a transflective reflector 24. The upper polarizer 16 and the transflective reflector 24 are attached to two sides of the display panel 12 through an upper adhesive 20 and a lower adhesive 22 respectively.

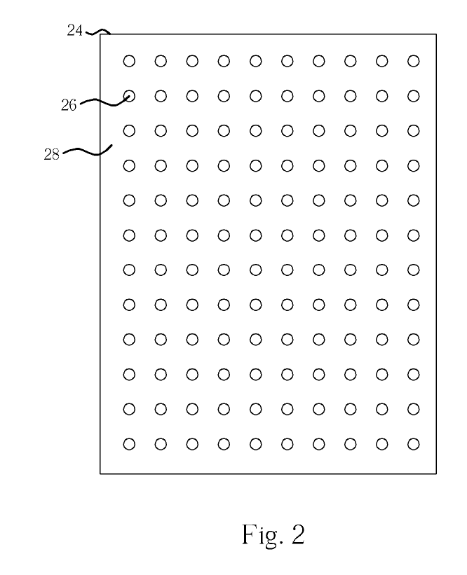

Please refer to FIG. 2. FIG. 2 is a schematic diagram of a frontal view of the transflective reflector 24 in FIG. 1. The transflective reflector 24 is a transparent thin plate which comprises a plurality of reflective patterns 26 on its surfaces. Therefore, light passing through the display panel 12 and reaching the reflective patterns 24 may be completely reflected by the reflective patterns 24 and back into the display panel 12 to be reutilized to improve the brightness of the display images, as the arrows indicate. In addition, the portion of surface of the transflective reflector 24 without the reflective patterns 26 is the light-penetrating region 28 which allows light to propagate and continue forward. Hence the rate of penetration and the rate of reflection of the transflective reflector 24 are determined by the ratio of the area of the reflective patterns 26 to the area of the transflective reflector 24. Moreover, the reflective patterns 26 may be composed by reflective semi-transparent materials, such as photoresist materials or metal thin films. The surfaces of the reflective patterns 26 may be selectively roughened to increase the scattering of the reflected light. Or the reflective patterns 26 themselves may be the rough surfaces f the transparent thin plate to create the effects of reflection and diffusion of light.

In preferable embodiments, the reflective patterns 26 are arranged in an array, as shown in FIG. 2, to create an even reflective rate on the entire transflective reflector. In addition, in more preferable embodiments, the reflective patterns 26 are set to evenly corresponding to each pixel or sub-pixel of the display panel 12. For example, each sub-pixel may include a reflective pattern 26 to ensure light is reflected in each pixel and increase the brightness of the entire display panel 12. However, the transflective reflector 24 in this invention is not limited to the form that depends on the area of reflective patterns 26. It may be other thin plates which partially reflect light and allow some light to propagate, such as a semi-transparent panel.

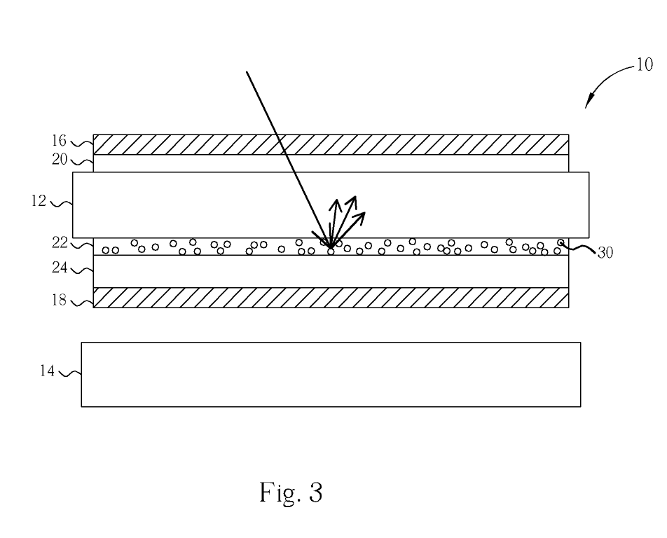

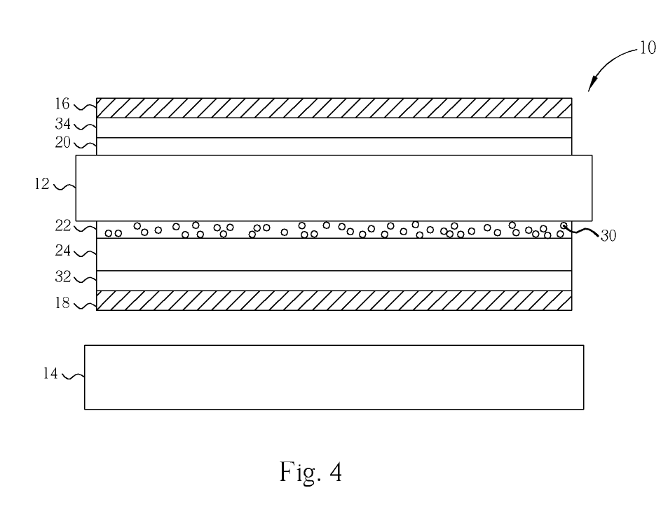

Please refer to FIGS. 3-4. FIGS. 3-4 are cross-section schematic diagrams of displays according to a second and a third embodiment of this invention respectively. All symbols of parts here are the same as in FIG. 1. In the second embodiment, the lower adhesive 22 is a scattering adhesive which comprises a plurality of diffusion particles 30 spread in the lower adhesive 22. The diffusion particles 30 are made of materials with functions of scattering or reflecting light. When light from the display panel 12 is transmitted into the lower adhesive 22 and reaches the diffusion particles 30 and the transflective reflector 24, it may be reflected and scattered back to the display panel 12, as the arrows indicate. Since the distribution density, size, shape, material, and arrangement position of diffusion particles 30 may influence the performance of light scattering, the variables of the diffusion particles 30 as mentioned previously may be different due to the differences of their arrangement positions and of the displays they are applied to. For example, in different arrangement positions in the lower adhesive 22, the distribution densities of the diffusion particles 30 may be completely different. The display 10 shown in FIG. 4 also comprises a lower retardation film 32 and an upper retardation film 34 in the inner side of the lower polarizer 18 and the upper polarizer 16 respectively to recover the problem of chromatic polarization resulting from the process of reflection and diffusion of light.

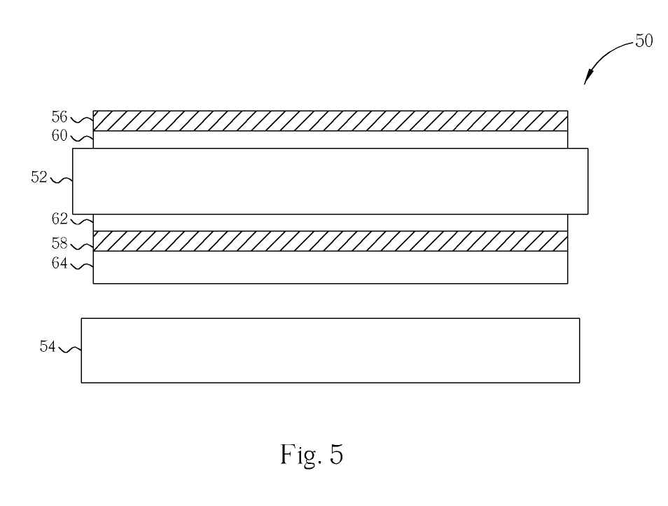

Referring to FIG. 5, FIG. 5 is a cross-section schematic diagram of a display according to a forth embodiment of this invention. The display 50 comprises a display panel 52 and a backlight module 54. On the upper surface and lower surface of the display panel 50 are an upper polarizer 56 and a lower polarizer 58 respectively which are attached to the surfaces of the display panel 52 via an upper adhesive 60 and a lower adhesive 62 separately. In addition, on the lower surface of the lower polarizer 58 is a transflective reflector 64 which may be the same as the transflective reflector 24 as in FIG. 2 or other thin plates with the function of partially reflecting light.

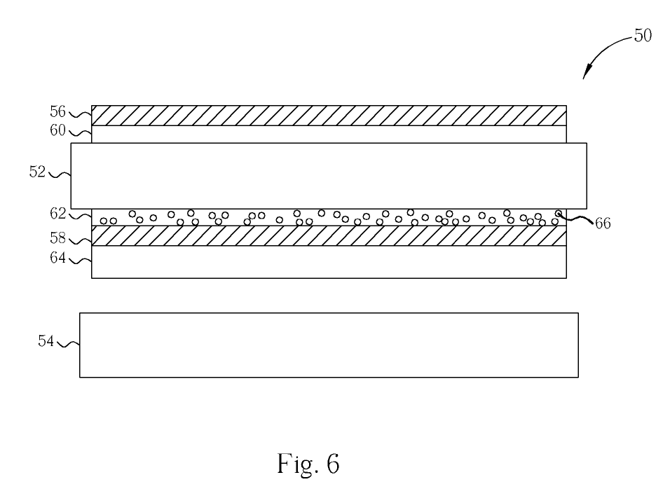

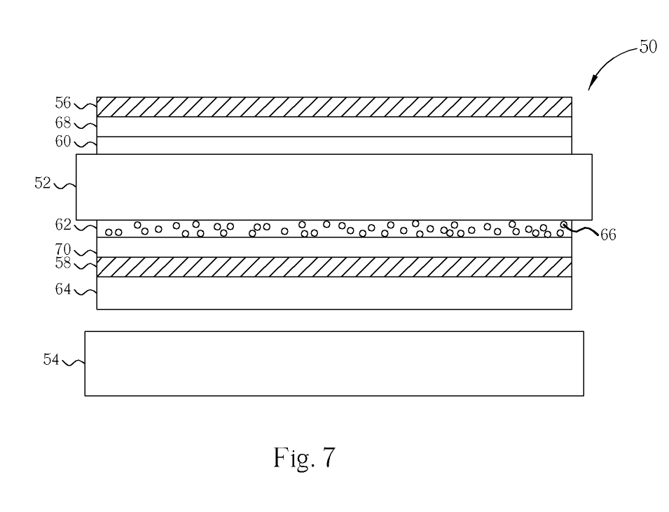

FIGS. 6-7 are cross-section schematic diagrams of displays according to a fifth and a sixth embodiment of this invention respectively. FIG. 6 shows a plurality of diffusion particles 66 are distributed in the lower adhesive 62 to enhance the diffusion of light and adjust the path of the reflected light. The embodiment in FIG. 7 has an upper retardation film 68 between the upper polarizer 56 and the display panel 52 and a lower retardation film 70 between the lower polarizer 58 and the display panel 52. Since the scatter and reflection of light may create problems of chromatic polarization and weaken the intensity of light with certain wavelengths, the upper and lower retardation films 68, 70 for certain wavelengths may be provided to improve the display images.

In contrast to the prior art, this invention provides a transflective reflector on the lower surface of the display panel to improve the brightness of the entire display images by partially reflecting light from external ambient light sources passing into the display panel. Furthermore, since the transflective reflector may reflect ambient light, the goal of reducing power consumption may be reached because the user may still see clear images on the display while the backlight source is off or light source with relatively low brightness is provided by the backlight module. In addition, since the transifective reflector in this invention uses reflective patterns to create the function of reflecting light, its rate of reflection and rate of penetration may be adjusted easily by changing the area and the shape of the reflective patterns, so that better displays may be designed by utilizing simple manufacturing processes and methods.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display comprising:
a display panel;
a transflective reflector positioned on a lower surface of the display panel;
an upper polarizer positioned on an upper surface of the display panel;
a lower polarizer positioned on a lower surface of the transflective reflector; and
a backlight module positioned on a lower side of the lower polarizer for providing a backlight source to the display panel.

2. The display of claim 1, wherein a surface of the transflective reflector comprises a plurality of reflective patterns and a reflective rate of the transflective reflector which is determined by the ratio of the area of the reflective patterns to the area of the transflective reflector since the reflective patterns completely reflect light while the other portions of the transflective reflector without the reflective patterns allow light to propagate directly.

3. The display of claim 1, wherein materials of the reflective patterns are transflective and comprise a coating with photoresist materials or a metal thin film for reflecting light.

4. The display of claim 2, wherein the reflective patterns are arranged in an array.

5. The display of claim 2, wherein the reflective patterns are individually corresponding to a pixel of the display panel.

6. The display of claim 2, wherein the reflective patterns comprising photoresist materials or metal materials.

7. The display of claim 2, wherein the reflective patterns comprise rough surfaces that scatter reflected light.

8. The display of claim 1, wherein the display further comprises a scattering adhesive to attach the transflective reflector to the lower surface of the display panel, and the scattering adhesive is capable of scattering light.

9. The display of claim 8, wherein the scattering adhesive comprises a plurality of diffusion particles distributed in the scattering adhesive, the diffusion particles scattering light.

10. The display of claim 8, wherein the diffusion particles have different distribution densities, shapes, sizes, or materials in the scattering adhesive.

11. The display of claim 1, wherein the display further comprises at least a retardation film between the upper polarizer and the display panel or between the lower polarizer and the display panel.

12. A display comprises:
a display panel;
an upper polarizer positioned on an upper surface of the display panel;
a lower polarizer positioned on a lower surface of the display panel;
a transflective reflector positioned on a lower surface of the lower polarizer and comprising at least a reflective pattern, a reflective rate of the transflective reflector being determined by the ratio of an area of the reflective pattern to the area of the transflective reflector since the reflective pattern reflects light while the other portions of the transflective reflector without the reflective pattern allow light to directly propagate; and
a backlight module positioned on a lower side of the transflective reflector for providing a backlight source to the display panel.

13. The display of claim 12, wherein the material of the reflective pattern is transflective and comprises a coating with photoresist materials or a metal thin film for reflecting light.

14. The display of claim 12, wherein the transflective reflector comprises a plurality of the reflective patterns which are arranged in an array.

15. The display of claim 14, wherein the reflective patterns are individually corresponding to a pixel of the display panel.

16. The display of claim 12, wherein the reflective pattern comprises a photoresist material or a metal material.

17. The display of claim 12, wherein the reflective pattern comprises a rough surface that scatters reflected light.

18. The display of claim 12, wherein the display further comprises a scattering adhesive to attach the lower polarizer to the lower surface of the display panel, and the scattering adhesive is capable of scattering light.

19. The display of claim 18, wherein the scattering adhesive comprises a plurality of diffusion particles distributed in the scattering adhesive, the diffusion particles scattering light.

20. The display of claim 19, wherein the diffusion particles have different distribution densities, shapes, sizes, or materials in the scattering adhesive.

21. The display of claim 12, wherein the display further comprises at least a retardation film positioned between the upper polarizer and the display panel or between the lower polarizer and the display panel.
